(19) United States
(12) Patent Application Publication
(10) Pub. No.: US 2003/0195650 A1
(43) Pub. Date: Oct. 16, 2003

(54) Change-and-wait controller

(76) Inventors: Lorne Danielson, Langley (CA); David H. Sawrey, Vancouver (CA); Chester L. Nachtigal, Seattle, WA (US)

Correspondence Address: Chester L. Nachtigal, 6810 31st AVE NE, SEATTLE, WA, 98115, US

(21) Appl. No.: 10/122,053

(22) Filed: Apr. 15, 2002

(51) Int. Cl. G05D 23/00; G05B 21/00; G05B 15/00; G01M 1/38; G06F 7/00; G05B 13/02; G05B 13/00

(52) U.S. Cl. 700/213; 700/275

(57) ABSTRACT

A multi-purpose controller for controlling the flow rate of material being transported in a suitable conduit for the particular material being transported includes a means for calculating an index of the measured flow rate over a selected period of time. This calculated index, such as the arithmetic mean of a number of sampled values of the flow rate, is then compared with the reference or set point input to the controller. The resulting error signal is used to calculate a correction to the previously determined control signal, which is then used as an updated control signal at the input of the flow rate actuator. The repetitive operations of calculating an up-dated flow rate index, comparing the index with the reference input, calculating an up-dated control signal, and so forth is time-coordinated by means of a wait time interval that is related to the inherent time delay of the material time in transit from the flow rate modulator to the flow rate measurement sensor location. Thus the user will find it extremely easy to set up for the particular application that is to be controlled by the Change-and-Wait controller.

The disclosure describes a system comprised of a conveyor belt used for transporting mined materials such as aggregate material from one location to another with the objective of maintaining a high level of productivity. A belt scale is typically used as a flow rate sensor for this type of mining operation. The controller itself may be implemented by means of a simple digital computing structure such as a Programmable Logic Controller (PLC).

### FIELD OF INVENTION

This invention relates to systems of flowing material, especially where material is in transit from one location to another; more particularly, to the aspect of controlling the flow rate in the face of variations of flow rate that are not acceptable. Aggregate materials conveyed by belt conveyors fall into this description and indeed the first implementation of this controller was in the processing of aggregate materials.

### BACKGROUND OF INVENTION AND PRIOR ART

The most commonly used process controller in industry even to this day is the three-term PID controller. It began to be accepted as a necessity for a wide variety of industrial processes in the early 1930s in closed-loop control applications. Closed-loop control refers to an arrangement of components such that a measurement sensor monitors the process variable of interest and an actuator or modulator responds in a manner that corrects the process variable as it changes over time. But the PID construct was difficult to use at that time because of the need to set not one but three separate parameter values: the proportional gain, the reset gain, and the derivative gain. Appropriate values for these parameters are intimately related to the dynamic response of the system to be controlled, and prior to 1940 there was no known simple method for selecting good, let alone optimum controller parameter values. All this changed with the publication of “Optimum Settings for Automatic Controllers”, published by J. G. Ziegler and N. B. Nichols in the November 1942 issue of Transactions of the ASME, pp. 759-768. Even today hundreds of thousands of this controller are purchased every year by the industrial community.

FIG. 1 shows this classical controller in the context of a system with transit delay, sometimes called pure time delay, or transport delay. The time delay term is also called (mistakenly) time lag. In this patent application we will carefully distinguish (as is done in the automatic control literature) between these two terms. Time lag is the mathematical characterization of any dynamic system's non-instantaneous response to an input such as a step change in the set point. Transport delay is the transit time required for material to flow from one point to another in the system. For purposes of this patent application, the transport delay is the time required for material to flow from the flow actuator or modulator to the measurement point. If the sensor is accurate, it will replicate the process variable events that occurred at the flow actuator a short time ago.

The PID controller works as follows: an error signal is formed by subtracting the measured process variable (flow rate for a belt conveyor process) from the input desired flow rate. The controller operates on this error signal to drive the actual process variable into congruence with the input desired value, also called the set point (two words) flow rate. If the actual flow rate is less than the set point value, the error is positive and the controller immediately creates more output in order to drive the process harder, with the objective of driving the error to zero. The ‘P’ term is proportional, which means multiplying the error by a constant. The ‘I’ term is integral, which means integrating the error over time to overcome any inherent offset, however small, between the set point and the measured process variable, or feedback signal. This term ensures that at steady state the output will follow the input set point perfectly without error. If it were not for this integral term, the error would always have to be positive or the controller output would collapse to zero—no drive signal to the process actuator at all. Gates would close, feeders would stop, etc. The ‘D’ term means derivative, which means the controller also operates on the rate of change of the error signal, resulting in an anticipatory or speedier response to a time-varying error.

The output of a PID controller instantly responds to a change in the error. But in the case of a flowing material where the measurement point—such as a belt scale in the aggregate industry—is located some distance downstream of the process actuator (a vibratory feeder or a feed gate), an upset or disturbance in the process flow rate at the flow rate actuator cannot be sensed immediately. The disturbed flow rate has to arrive at the measurement location before the control system can sense that a correction needs to be made. Suppose that the process flow rate was reduced, for example, by larger than usual particles of aggregate in the flow stream. After one process time delay has elapsed, the sensor determines that the flow rate is less than the desired value, thereby causing a positive error in flow rate. A PID controller will immediately set about correcting the flow rate error by means of all three of its terms, thereby commanding the flow actuator to produce more flow. During the entire second time delay the integral term will continue to increase its output without regard to the new flow rate created by the continuously increasing output from the integral term. This happens because the error remains constant until the increased flow rate arrives at the sensing location. By this time the flow rate could very well exceed the correct value because of the continuous correction action of the I term and the process time delay. Thus the PID controller is likely to overcorrect, both during the positive error time delay period and also in the negative error direction during a subsequent delay period. This repeated over-correction can cause hunting in the process under control, a very undesirable behavior.

On a more rigorous mathematical note, controllability of the PID algorithm is based on a mathematical model of the process and optimum performance of the resulting closed-loop system requires correct setting of the proportional, integral and derivative gains. These parameter values are dependent upon multiple process response times (any number of first- and second-order time lags that act as the process's ‘inertias’) and the process ‘gain constant.’ In real-world situations these characteristics rarely remain constant. Also, few real processes are linear throughout their operating range. Thus the PID gain terms must be ‘re-tuned’ with changes in the process. If the PID parameters are not updated, control will be very sluggish or go into unstable oscillatory operation (earlier described as hunting). PID settings are at best a compromise of acceptable response under most operating conditions.

The preceding discussion highlighted the shortcomings of a PID controller in the face of systems having a time delay. Many real systems in fact have both time delay and time lag—and it is difficult to separate the two when observing the response to an input such as a set point step change So it is appropriate to expand the field of this invention to include systems that are simply sluggish and slow in regard to the response of the process whether due to a time lag or a time delay or a mixture of the two.

In addition to the essential control action of forming an error between the desired and the actual process variable, prior art closed-loop controllers also typically have one or more logic outputs that are either OFF or ON. During normal operation this type of output is usually in the OFF state. It switches to ON if the relationship between input desired value and the process actual variable exceeds the user-specified tolerance condition. This switching action from OFF to ON, often referred to as a setpoint (one word), may be used to display or sound an alarm to alert the operator or as a secondary control signal.

### OBJECTS AND ADVANTAGES

It is an object of this invention to provide a controller targeted for closed-loop control of conveyed materials where the flow rate sensor is necessarily located downstream of the flow actuator.

Another object is to create a controller generally suited for controlling the flow rate of a variety of industrial processes where the sensor is located downstream of the flow modulator, including materials such as liquids and gases.

A very important objective is that the controller cannot easily be ‘fooled’ by changes in the process operating characteristics.

An important advantage of the controller described in this application is that it is easy for operators to understand its principles of operation and to determine the controller parameter values for the process to be controlled.

A human operator without benefit of a closed-loop control system is capable of controlling a variety of quite difficult processes manually. So it is an advantage of the Change-and-Wait controller that it utilizes simple setup concepts that resemble how a skilled operator would react to process errors.

In addition to offering a setup that is easier to understand, this controller provides better closed-loop control response.

Yet another advantage of this new controller is that it does not exhibit hunting response.

### BRIEF DESCRIPTION OF FIGURES

FIG. 1 is a prior art block diagram of a generic process equipped with a PID controller.

FIG. 2 is a block diagram description of a belt conveyor with a belt scale to measure flow rate and a Change-and-Wait controller to maintain the flow rate at a desired level.

FIG. 3a) shows a typical conveyor flow rate signal at the belt scale measurement point in the system.

FIG. 3b) shows the same flow rate as in FIG. 3a) but occurring earlier in time at the outflow of the flow actuator.

FIG. 4 is a block diagram of the Change-and-Wait controller alone with its inputs and outputs shown.

FIG. 5 is a generic block diagram of a Change-and-Wait controller at work controlling a flowing material constrained by a closed conduit, as would be the case if the material were a liquid, a gas, or a slurry.

FIG. 6 shows a representation of a stirred mixing tank with inflow and outflow and control inputs to provide for either positive or negative actuation of the process variable property of interest.

### DETAILED DESCRIPTION OF THE INVENTION

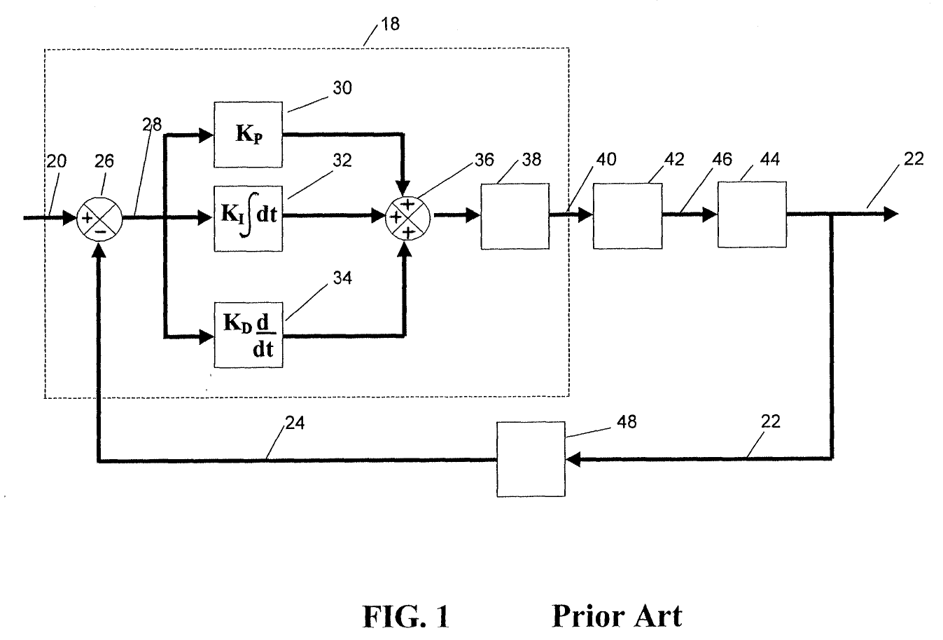

FIG. 1 shows the generic make-up of a system with time delay 44 under closed-loop control by a prior-art PID controller 18, also called a three-term controller because of its three concurrent mathematical operations 30, 32, 34 on the error signal 28. The reference signal 20 conveys information to the controller about the desired value of the system process variable 46 that is unavoidably time delayed 44 before it is presented 22 to the process variable sensor 48. An example of such an unavoidable time delay is a conveyor belt carrying material wherein the belt scale needed to measure the material flow rate is some distance away from the material flow modulating mechanism.

Referring again to FIG. 1, the measured version 24 of the delayed process variable 22 is fed back and compared with the Reference Input 20 at the summing junction 26 of the PID controller 18, where an error signal 28 is created and fed simultaneously to the three controller operators—the proportional term 30, the integral term 32, and the derivative term 34. The three outputs of these individual operations are summed at 36 and become a single signal in real time that is converted by 38 to a controller output signal 40. This signal serves as the input to the process variable actuator 42 that modulates the process variable 46 at the command of the PID controller 18 so as to drive the process variable into congruence with the Reference Input 20.

A simple example of why the afore-described PID controller is sometimes ineffective in bringing about smooth control of the ever-changing process variable can be found in the ordinary home shower bath arrangement. If an upset in shower temperature occurs due to sudden onset of demand for cold water supply, the controller (person taking a shower bath) suddenly and frantically reaches for the control valve to increase the water emperature. Suppose the piping length between the shower mixing valve and the controller (person) is quite long. Then there would be a significant time delay between the actuation of the water stream temperature and the sensing of the change in temperature. Suppose further that the person taking the shower bath was unaccustomed to the inordinately long time delay, resulting in the person continuing to correct the water temperature during the time delay period. When the time delay period expires and the temperature-corrected water arrives at the shower head, it is likely much too hot for comfort owing to the fact that the “controller” continued to make corrections during the time delay period when no changes in water temperature could be sensed. Similarly, a PID controller will continue to make corrections during a time delay period because its integral term is operating on a constant and unchanging error signal, thus integrating the error over time and arriving at an output signal value that is too high. In the next time delay period the corrective action is likely to undershoot the needed correction in responding to the first over-correction attempt.

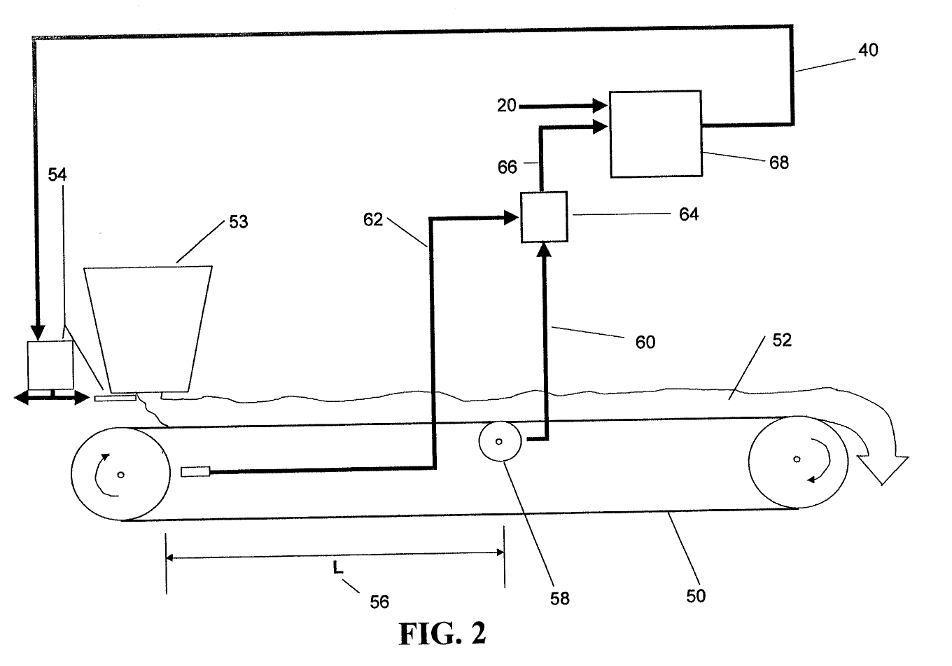

FIG. 2 illustrates the implementation of a Change-and Wait controller in the context of a conveyor belt transporting material from one point to another, such as is typically found in the aggregate and mining industries. A belt 50 loaded with material 52 flowing from a hopper 53 is weighed at location 58 a distance L 56 downstream of the hopper feeding point. The hopper outflow is modulated by a gate connected to an appropriate actuator and electronic device 54 for positioning the gate, thereby increasing or reducing the outflow. It is understood that a variety of feeding arrangements could be implemented to achieve modulated material outflow from a source in place of the hopper-and-gate assembly shown in FIG. 2. For example, a vibratory feeder that can have its vibration rate modulated is one such alternate arrangement. The weight signal 60 from a weighed section of the belt together with an appropriate belt motion signal 62 is sent to a belt scale totalizer 64 that calculates the material flow rate 66, such as in units of tons per hour. A Change-and-Wait controller 68 that is the subject of this patent disclosure receives this flow rate signal 66 and compares it with a reference signal 20 that provides information to the controller 68 regarding the desired flow rate that the conveyor belt 50 is to transport between the two points spanned by the conveyor system.

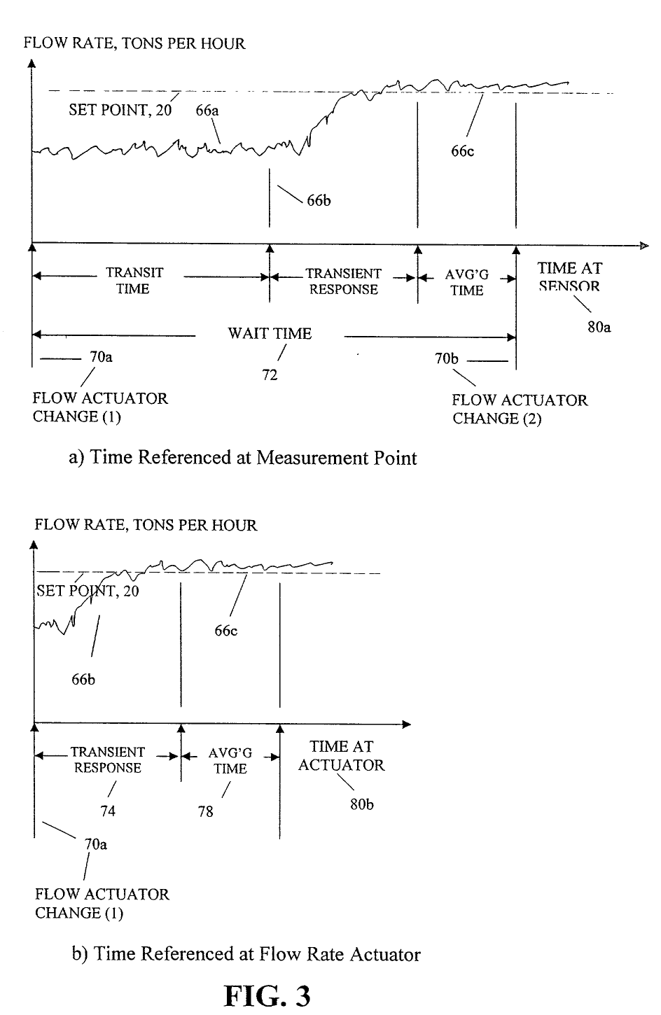

If the measured and calculated flow rate as determined by the belt scale acting as a material flow rate sensor is larger or smaller than the flow rate transmitted to the controller by the reference signal 20, the controller 68 will take appropriate control action by changing the position of the material gate 54, either reducing the opening or increasing it, thereby restoring the flow rate to the reference value. The actual steps the controller will take in changing the gate position is described in the context of FIG. 3.

FIG. 3 shows two example time traces of the characteristics of a Change-and-Wait controller. FIG. 3a) is time-referenced at the belt scale location a distance L 56 downstream of the feed hopper 53 while FIG. 3b) is time-referenced at the material gate 54 of the hopper. Suppose for purposes of these two time traces of flow rate that a sudden increase in set point occurred at time less than t=0 and that the gate has just been opened at t=0 to admit a greater flow rate of material onto the belt to meet the just recently imposed new reference flow rate value. Referring to FIG. 3a), notice that no change in measured flow rate occurs until the Transit Time 74 has elapsed. This time is implicit in FIG. 2, distance L 56 and belt speed: Transit Time=L/feet per second belt speed. At this time in FIG. 3a) the material Transient Response 76 begins. This time period is very brief and perhaps is inconsequential. Lastly, the Averaging Time 78 begins. Taken together, two time parameter values are user-entered into the Change-and-Wait controller: the overall Wait Time 72 and the Averaging Time 78. As indicated above, the user can readily calculate the Transit Time from knowledge of the displaced belt scale distance L 56 and the reasonably constant belt speed. A small additional time can be added to allow for the transient response of the material flow rate emerging from the changed material gate positioning mechanism 54. A typical Averaging Time of two to three seconds has been found to be adequate. FIG. 3b) is shown as a reminder of what actually happens after t=0 at the material gate. But flow rate cannot be measured at that location, so the true flow rate shown in FIG. 3b) remains hypothetical.

The controller is thereby programmed and instructed to carry out the following sequential steps over and over:

Change the controller output (input to the flow actuator)

Wait for transit time to elapse and for the transient to die down

Average the new flow rate and calculate a new error

Change the controller output again based on new error and last control output

The preceding description has to do with a sudden change in the Reference Input 20 and the controller's response to that change. It should be stated that the starting time reference in FIG. 3a) coincides with the end of the Averaging Time 78 of the controller and thus the material gate change in position has just occurred at time t=0. If the change in Reference Input 20 occurs somewhat before the Averaging Time 78 is scheduled to begin, the normal Wait Time 72 of the controller would continue without immediate response to the changed Reference Input. However, the capability of responding immediately to a change of the Reference Input is well within the scope of this invention.

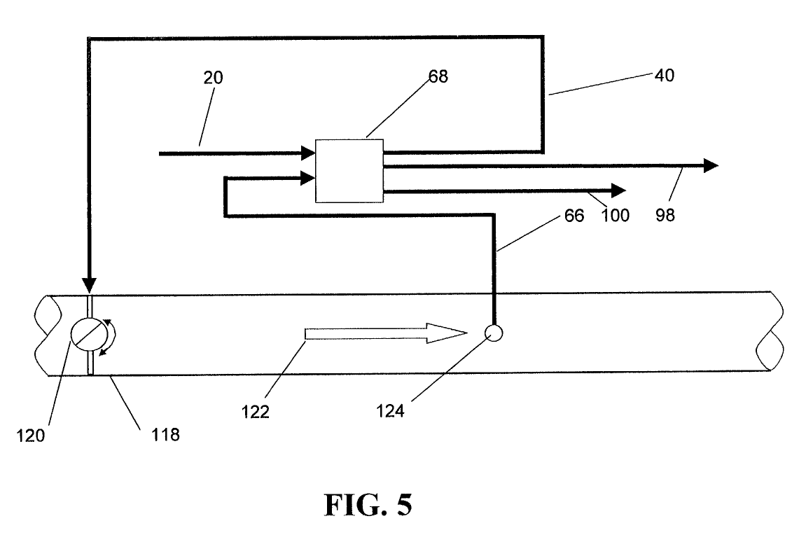

Yet another aspect of the controller's response to a mismatch between Reference Input flow rate and the measured flow rate (or an average thereof) occurs when the material flow rate changes significantly on its own, such as when the coarseness and/or viscosity of the flowing material is suddenly different from a short time ago. This frequently occurs in aggregate mining operations when a vein of wetter or larger particle size is encountered. Suppose that in FIG. 3b) the actual flow rate suddenly decreased a short time before t=0 due to a change in its own properties, and the Reference Input remains fixed. The subsequent controller response to such a suddenly reduced flow rate would be the same as shown in FIGS. 3a) and 3b). For both the response to Reference Input change and to change in material properties, a more realistic pattern of measured flow rate than the one shown during the Transit Time 74 in FIG. 3a) would be a continuously changing flow rate with peaks and valleys considerably higher and lower than those shown in this application. Another comment that could be reserved for the discussion of FIG. 5 is that the uncontrolled variations in flow rate will be different depending on the specific characteristics of the material itself. For example, this invention was first implemented in the aggregate mining industry where the raw material is known to change quite drastically in size, smoothness, and moisture content that causes change in viscosity.

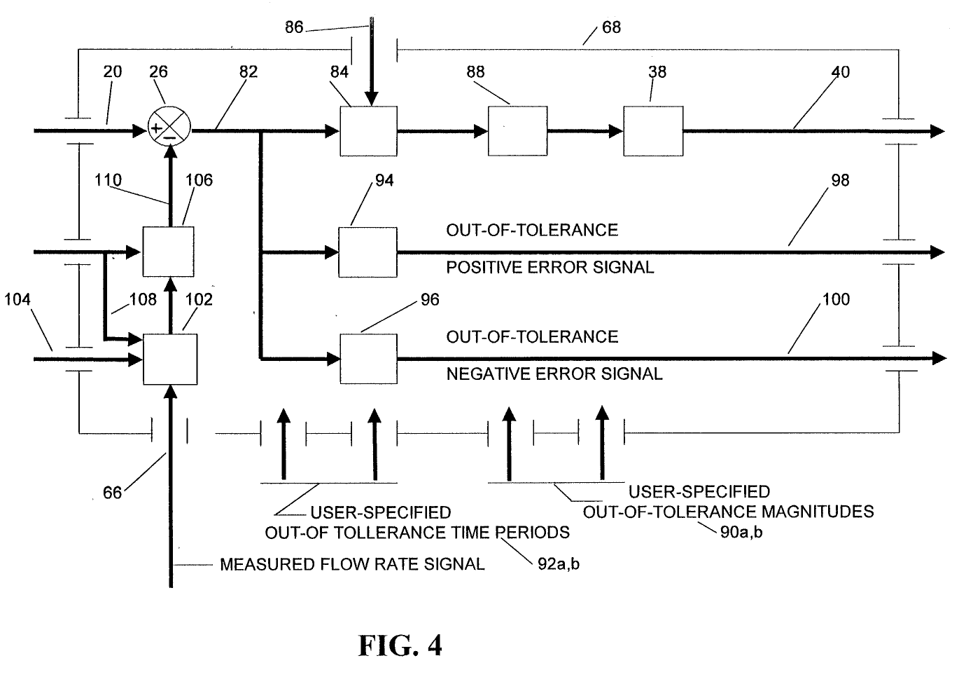

FIG. 4 is a detailed representation of the closed-loop control features of the Change-and-Wait controller plus additional OFF/ON alarm or control outputs. These additional OFF/ON outputs will be described later. First, the details of the controller action as described in the context of FIG. 3. The measured flow rate signal 66 is fed continuously into a Wait Time generator 102 that simply stands idle until the end of a time period of duration (Wait Time—Averaging Time). At this time the measured signal is passed on to the Flow Rate Averaging module 106 where it is averaged for the duration of Averaging Time 108. The user-supplied Wait Time value 104 is supplied to and retained by module 102 as well as Averaging Time 108. At the end of the Averaging Time duration, the new average value of flow rate 110 is sent to the so-called summing junction 26 where the new average value is subtracted from the incoming Reference Input 20. The resulting Error signal 82 is then passed on to module 84 where it is multiplied by the user-supplied Error Adjust value 86. The output of module 84 is transmitted to module 88 where the new (Error X Error Adjust) portion is added to similar prior accumulated adjustments The output of module 88 is then converted by module 38 to a form that is recognizable by the electronic interface of the Material Feeder Flow Rate Actuator 54. Typically the control signal 40 is in the form of a 4 to 20 mA analog electrical current −4 ma to represent a closed gate position and 20 mA to represent a wide-open gate position. It must be recognized that there are various scaling factors throughout the chain of events just described For example, the incoming signal 66 from a belt scale acting as a material flow rate sensor is typically in the form of a 4 to 20 mA current. This signal can be correctly interpreted only if a scaling factor (Tons per hour/mA) is also supplied to the Change-and-Wait controller. These necessary details, while important and necessary, are not fundamentally a new invention disclosed here.

FIG. 4 presents several digital OFF/ON features useful as over-riding control outputs in the event that the closed-loop control action is unable to achieve the desired corrective action. Module 94 is a digital switch that turns from OFF to ON if the Error signal 82 is positive and larger than a user-specified Out-of-Tolerance Magnitude 90a, and if Error simultaneously remains too large for a period of time longer than the user-specified Out-of-Tolerance Time Period 92a. The digital output signal 98 may be thought of as an electrically conducting circuit that can be externally connected to an audible-emitting device or to a light-emitting device when it turns to ON. In this case the output signal 98 is used as an alarm to report that the flow rate is too small and the controller is unable to maintain or create a correspondence between the Reference Input 20 and the Measured Flow Rate 66.

Module 96 is a digital switch that turns from OFF to ON if the Error signal 82 is negative and larger in magnitude than a user-specified Out-of-Tolerance Magnitude 90b, and if Error remains negative and too large in magnitude for a period of time longer than the user-specified Out-of-Tolerance Time Period 92b. The digital output signal 100 may be thought of as an electrically conducting circuit that can be externally connected to an audible-emitting device or to a light-emitting device when it turns to ON. This alarm could send a signal that the flow rate is too large and cannot be brought under control. Alternatively, output signal 100 could be used to command a gate or valve to close completely in order to halt the wild, uncontrollable flow rate. As a third possibility, the output signal 100 could simultaneously trigger an alarm and close the afore-mentioned flow gate.

FIG. 5 shows implementation of a Change-and-Wait controller for a generic closed-channel flow application. Conduit 118 could used for the flow of liquids, slurries, or gases. Valve 120 is a proportionately adjustable flow modulator that has the appropriate interface for a control signal 40 produced by the Change-and-Wait controller. Item 124 is a suitable flow rate sensor for the type of material conducted by the conduit 118. Since this arrangement also has a transit time between the flow modulator and the measurement point, it too is a candidate for the type of controller disclosed in this patent application.

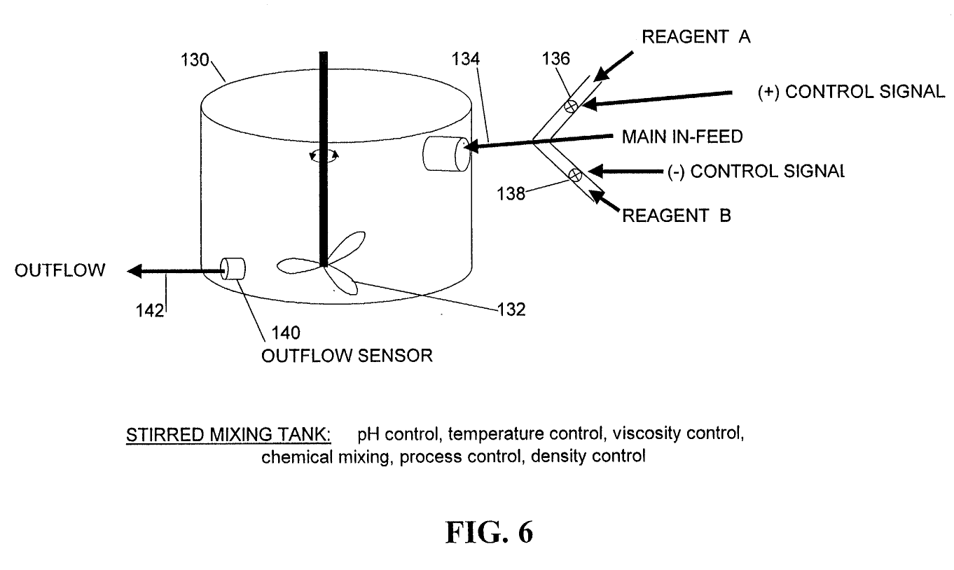

FIG. 6 represents a flowing system with a stirred mixing tank 130 to enable the process to be controlled before flowing out of the tank to the next processing step. The incoming material may be a liquid, a slurry, a two-phase substance, or a gas. The inflow channel or conduit 134 has two secondary ports 136, 138 for injecting additional material so as to increase or decrease the property of the process variable that is being controlled. For example, if temperature control is to be achieved with this stirred mixing tank, additional hot material 136 or additional cold material 138 could be injected by means of the control ports associated with the infeed. Similarly, if chemical equilibrium is to be achieved, or if PH (acid or base) control is the objective, the secondary ports serve as the process variable actuator to enable control of the process. Because of the variety of aspects in the context of flowing processes that may require control, the claims portion of this patent disclosure will use the designation process variable property when referring to that aspect of the flowing system that is to be controlled.

It is important to note that the mixing tank in FIG. 6 has both time delay and time lag that are significant when determining the dynamic response of the process variable property. If the property of interest in the incoming fluid varies from the desired value, the fluid in the mixing tank will immediately begin to assimilate the incoming property upset, but the equilibration process will be rather sluggish, depending on the size of the mixing tank compared with the flow rate and the stirring rotation rate of the paddle 132. Transit time is also important when considering the control task because it requires some time for the fluid to travel from the inlet to the sensor location. Thus it should be clear that a Change-and-Wait controller would have advantages over the PID controller for the same reasons that a system with time delay due to flow rate in a conduit can exhibit adverse behavior with a PID controller.

Summary and Concluding Remarks

From the previous description the reader can readily understand that the classical three-term PID controller is not adequate for a class of material flow applications where the measurement point is a significant distance downstream of the flow rate modulator. The reader can further conclude that a Change-and-Wait controller described herein is both easy to understand and to use. Furthermore, it is intuitively obvious that the change and then wait control action disclosed by this patent application is well-suited for systems that have such a time delay. Furthermore, a system having a sluggish dynamic response can benefit from a Change-and-Wait controller for the same reasons as a system with transit time.

We claim:

1. A multi-purpose controller for maintaining a desired flow rate of solid material in transit on a conveyor belt, comprising:
means for inputting a desired flow rate reference signal into the controller;
means for receiving a signal from a material flow rate measurement sensor;
means for waiting a user-specified first time period, after the elapse of which said time period operating on said measured flow rate signal commences;
means for quantifiably interpreting said signal in terms of said flow rate occurring on said conveyor belt;
means for determining an index of said flow rate spanning over a user-specified second time period;
means for calculating the excess or deficiency of said flow rate index relative to said input desired flow rate, thereby creating an internal flow rate error;
means for determining a needed change in controller output based on said created internal flow rate error;
means for increasing or decreasing an earlier-determined controller output that is the input to a source flow rate actuator, thereby creating an updated controller output and changing said source flow rate in accordance with and in response to said updated signal from said flow rate controller;
means for repeating the cycle of receiving said flow rate signal, waiting said first time period, quantifiably interpreting, index determining, and controller output changing operations, thereby creating a repeating Change-and-Wait control strategy that continually provides controlled corrections to the process.

2. A multi-purpose controller according to claim 1 with an embedded electronic calculational device used to perform the necessary calculations.

3. A multi-purpose controller according to claim 1 wherein the flow rate index determination consists of time-averaging said flow rate measurement signal, and wherein the time-averaging occurs over said second time period selected by the user.

4. A multi-purpose controller according to claim 1, further including means for issuing secondary controller outputs in the event that said flow rate on said conveyor belt remains in violation of a user-specified tolerance relationship relative to said input desired flow rate; whereby a user of this controller benefits from additional means for controlling the process, such as shutting off the flow entirely if the flow exceeds the tolerance condition.

5. A multi-purpose controller according to claim 4, further including means for user entry of at least one tolerance condition that applies when said flow rate index is larger than said input desired flow rate, and at least one tolerance condition that applies when said flow rate index is smaller than said input desired flow rate.

6. A multi-purpose controller according to claim 5 wherein each of said tolerance conditions are comprised of two parts: said flow rate index being larger than said input desired flow rate and said flow rate index remaining larger than said input desired flow rate for a user-selected third time period; and a second tolerance condition wherein said flow rate index is smaller than said input desired flow rate and remains smaller for a user-selected fourth time period.

7. A multi-purpose controller according to claim 1 wherein said input desired flow rate can be a time-varying signal.

8. A multi-purpose controller according to claim 7 wherein said time-varying input desired flow rate signal is time-averaged over same said second time period as the flow rate measurement signal thereby ensuring that said internal flow rate error consists of two time-averaged indices determined over the same time period.

9. A multi-purpose controller for modulating the flow rate of solid, liquid, or gaseous material being transported in a suitable conduit means wherein the measurement point of said material flow rate is located some distance downstream of a flow rate actuator and for maintaining a correspondence between said material flow rate and a reference or desired flow rate, comprising:
means for inputting a desired flow rate reference signal into the controller;
means for receiving a signal from a material flow rate measurement sensor;
means for waiting a user-specified first time period, after the elapse of which said time period operating on said measured flow rate signal commences;
means for quantifiably interpreting said signal in terms of said flow rate occurring in said conduit;
means for determining a first index of said measured flow rate signal spanning a user-specified second time period;
means for calculating the excess or deficiency of said first flow rate index relative to the said reference flow rate, also commonly referred to as the set point in the control industry, thereby creating an internal flow rate error;
means for determining a needed change in controller output based on said created internal flow rate error;
means for increasing or decreasing an earlier-determined controller output that is the input to a source flow rate actuator, thereby creating an updated controller output and changing said flow rate in accordance with and in response to said updated signal from said flow rate controller;
means for repeating the cycle of receiving said flow rate signal, waiting said first time period, quantifiably interpreting, index determining, and controller output changing operations, thereby creating a repetitive Change-and-Wait control strategy applicable to a wide variety of applications where material is in transit in a suitable conduit.

10. A multi-purpose controller according to claim 9, having an embedded electronic calculational device used to perform the necessary calculations.

11. A multi-purpose controller according to claim 9, wherein the reference flow rate may be a time-varying reference flow rate signal.

12. A multi-purpose controller according to claim 11 wherein a second flow rate index is aggregated from said time-varying reference flow rate signal in a manner similar to the determination of said first index from said measured flow rate signal.

13. A multi-purpose controller according to claim 11 wherein said second flow rate index is combined with said first flow rate index; thereby creating an internal flow rate error based on two time-varying flow rate signals.

14. A multi-purpose controller according to claim 9, further including means for issuing secondary controller outputs in the event that said flow rate in said conduit remains in violation of a user-specified tolerance relationship relative to said reference flow rate, thereby enhancing the control capability of a Change-and-Wait controller.

15. A multi-purpose controller according to claim 14, further including means for user entry of at least one tolerance condition that applies when said first flow rate index is larger than said reference flow rate; and at least another tolerance condition that applies when said first flow rate index is smaller than said reference flow rate.

16. A multi-purpose controller according to claim 15 wherein each of said tolerance conditions is comprised of two parts: said first flow rate index being larger than said reference flow rate and said first flow rate index remaining larger than said reference flow rate for a user-selected third time period; and a second tolerance condition wherein said first flow rate index is smaller than said reference flow rate and remains smaller for a user-selected fourth time period.

17. A multi-purpose controller for controlling a process variable property of interest in a flowing system, comprising:
means for inputting a desired process variable property reference signal into said controller;
means for receiving a signal from a process variable property measurement sensor;
means for waiting a user-specified first time period, after the elapse of which said time period operating on said measured process variable property signal commences;
means for quantifiably interpreting said signal in terms of said process variable property occurring in said process variable;
means for determining a first index of said measured process variable property signal spanning a user-specified second time period;
means for calculating the excess or deficiency of said first index relative to said process variable property reference signal, also commonly referred to as a set point in the control industry, thereby creating an internal process variable property error;
means for determining a needed change in controller output based on said created internal process variable property error;
means for increasing or decreasing an earlier-determined controller output that is the input to one or the other of a pair of process variable property actuators, thereby creating an updated controller output and changing said process variable property in accordance with and in response to said updated signal from said controller;
means for repeating the cycle of receiving said process variable property signal, waiting said first time period, quantifiably interpreting, index determining, and controller output changing operations, thereby creating a repetitive Change-and-Wait control strategy applicable to a wide variety of applications where a property of a flowing material is being controlled.

18. A multi-purpose controller according to claim 17, further including means for issuing secondary controller outputs in the event that said process variable property signal first index is in violation of at least one of several sets of user-specified and user-entered tolerance conditions.

19. A multi-purpose controller according to claim 18 wherein said sets of tolerance conditions are comprised of user-entered positive or negative departures of said process variable property first index from a desired process variable property second index and also remains in said tolerance condition violation for a user-entered continuous time period.

20. A multi-purpose controller according to claim 17 wherein said desired process variable property reference signal may be a time-varying signal with an index-determining time period that is substantially the same as said second time period.
